(19) United States
(12) Patent Application Publication
(10) Pub. No.: US 2024/0329215 A1
(43) Pub. Date: Oct. 3, 2024

(54) LIDAR CLEANING SYSTEM

(71) Applicant: Robert Bosch GmbH, Stuttgart (DE)

(72) Inventors: Peter Deak, Budapest (HU); Akos Hegyi, Mezöhegyes (HU); Bence Balint, Monor (HU); Gyorgy Szabo, Budapest (HU); Janos Simonovics, Dunaharaszti (HU); Mate Hornyak, Pakozd (HU); Zoltan Gyonyoru, Budapest (HU)

(21) Appl. No.: 18/611,907

(22) Filed: Mar. 21, 2024

(30) Foreign Application Priority Data
Mar. 27, 2023 (DE) 10 2023 202 765.8

(51) Int. Cl. G01S 7/497; B08B 1/16; B08B 13/00; G01S 17/931

(52) U.S. Cl. CPC G01S 7/497; B08B 1/16; B08B 13/00; G01S 17/931; G01S 2007/4977

(57) ABSTRACT

A LIDAR cleaning system includes an actuator configured to displace a first connecting member along a predetermined direction. A housing substantially completely encloses the actuator and the first connecting member. A wiper unit includes a second connecting member. The first connecting member and the second connecting member are force-conductively connected to each other. The housing is at least partially arranged between the first connecting member and the second connecting member and the actuator is configured to displace the wiper unit along the predetermined direction via the first connecting element and the second connecting element to clean a sensor surface of a LiDAR sensor.

### BACKGROUND

The present invention relates to a LiDAR cleaning system and a vehicle.

There are currently a plurality of different solutions for cleaning sensor surfaces in vehicles. Due to the increasing number of sensor surfaces to be cleaned on vehicles and autonomous driving, the demand for robust and innovative cleaning methods is continuously increasing.

Steady weight reduction in the vehicle area to reduce consumption and increasing competition create cost pressure so that cheaper and more efficient components for vehicles are more in demand.

### SUMMARY

The LiDAR cleaning system according to the present invention has the advantage over the known system that the housing can be configured completely around the actuator by means of the force-conductive connection between the first connecting means and the second connecting means, so that it is better protected from environmental influences. Thus, the service life of the LiDAR cleaning system can be significantly increased. Furthermore, the interchangeability of the wiper unit or the cleaning arm can be improved, as the wiper unit can be replaced by means of a simple handle due to the only force-conductive connection of the first and second connecting means, and therefore the entire LiDAR sensor or the entire LiDAR sensor assembly does not have to be replaced when the wiper units are replaced.

This is achieved according to the invention in that the LiDAR cleaning system comprises an actuator configured to displace a first connecting means along a predetermined direction. Furthermore, the LiDAR cleaning system comprises a housing, wherein the housing substantially completely encloses the actuator and the first connecting means. Furthermore, the LiDAR cleaning system comprises a wiper unit which has a second connecting means. The first connecting means and the second connecting means are connected to each other in a force-conductive manner. In addition, the housing is at least partially arranged between the first connecting means and the second connecting means. The actuator is configured to displace the wiper unit along the predetermined direction by means of the first connecting element and the second connecting element in order to clean a sensor surface of a LiDAR sensor.

In other words, the first and second connecting means form a magnetic coupling or the like, through which the actuator can displace the wiper unit of the sensor surface. The actuator is, for example, an electric motor, which can be displaced along the sensor surface on a corresponding guide. A first connecting means may be arranged on the actuator or the actuator may displace the first connecting means along the predetermined direction. The first connecting means can in particular be connected to a second connecting means in a force-conductive or a force-locking manner. The second connecting means is arranged on the wiper unit so that the actuator can displace the wiper unit along the predetermined direction in order to clean the sensor surface. The housing is in particular formed from a plastic or similar non-conductive material. Furthermore, the housing substantially completely encloses the actuator and the first connecting means such that both the actuator and the first connecting means are protected from environmental influences. Substantially completely here means in particular that, for example, a ventilation slot or a plug contact can be arranged in the housing in order to operate the actuator accordingly.

Preferably, the first connecting element and the second connecting element form a magnetic coupling to be force-conductively connected to each other.

An advantage of this embodiment is that the first connecting means and the second connecting means are releasably connected to one another by means of the magnetic coupling. Thus, in particular, the wiper unit on the LiDAR cleaning system can be replaced without having to loosen a fastener.

Preferably, the first connecting means is a permanent or electromagnetic magnet.

An advantage of this embodiment is that the permanent or electromagnetic magnet of the first connecting means may be arranged directly on the housing so that the wiper unit can be displaced along the predetermined direction.

Further preferably, the second connecting means is a permanent magnet and/or a magnetizable metal element.

An advantage of this embodiment is that when the second connecting means is configured as a permanent magnet, a higher force transmission can be achieved. If the second connecting means is configured as a magnetizable metal element, an advantage may be that this variant is particularly economical. Furthermore, both the permanent magnet and the magnetizable metal element can be arranged in contact with and sliding on the housing.

Preferably the housing comprises at least one guide element configured to form a pretensioning force on a lip of the wiper unit in order to clean the sensor surface.

An advantage of this embodiment is that the guide element can be used to increase the cleaning performance of the wiper unit by means of the lip and thus further improve the detection accuracy of the LiDAR sensor.

Preferably, the housing comprises at least two rails, wherein the wiper unit comprises at least two webs, wherein the two webs engage the two rails to displace the wiper unit along the sensor surface.

An advantage of this embodiment is that the degree of movement of the wiper unit can be limited to an axis by means of the rails and the webs, so that in particular tilting or the like of the wiper unit can be prevented. For example, the first of the at least two rails is arranged at a top side of the sensor surface. The second of the at least two rails may be arranged on a bottom side of the sensor surface. Preferably, the rails are arranged opposite to each other. The wiper unit comprises at least two webs, which may in particular engage the rails. A first web is arranged on the top side of the wiper unit, for example, so that it can engage the first rail. A second web is arranged at a bottom side of the wiper unit to engage the second rail. Thus, the wiper unit can be moved along the guide formed from the rails and the webs towards the sensor surface.

Further preferably, the at least two rails each comprise at least one sliding element, wherein the webs abut the respective sliding element.

An advantage of this embodiment is that the friction of the webs on the rails can be minimized by the sliding element, so that a lower force between the two connecting elements is required to displace the wiper unit along the sensor surface. For example, a sliding element may be arranged in the rail, wherein the sliding element forms a U-shape, for example, into which the web of the wiper unit engages.

Preferably, the at least two webs each comprise a tilting element extending along the at least two rails.

An advantage of this embodiment is that the tilting elements can further reduce the freedom of movement of the wiper unit. The webs of the wiper unit comprise the tilting element, which is, for example, a body extending along the direction of displacement, in particular at their flanks. Thus, tilting of the wiper unit along the displacement direction can be reduced.

Preferably, each of the tilting elements has at least two opposing slopes configured to clean the rails in which the slopes are arranged.

An advantage of this embodiment is that any debris such as rocks or the like that may become trapped in the rails can be conveyed out of the rail by way of the slopes on the tilting elements, so that the reliability of the LiDAR cleaning system can be further increased. Preferably, the tilting elements are provided with a slope in a cross-section towards the direction of displacement, such that the slope runs from the bottom to the tip of the rail.

Preferably, the sensor surface has a field of view of the LiDAR sensor, wherein the actuator is configured to displace the wiper unit to a parking position, wherein the parking position is arranged outside the field of view and/or the sensor surface, wherein the housing has a protrusion which covers the wiper unit in the parking position.

An advantage of this embodiment is that when the LiDAR cleaning system is not needed, the wiper unit is displaced to the parking position to protect it from rockfall or the like. Furthermore, an experience accuracy of the LiDAR sensor is better when the wiper unit is not on the sensor interface or in the field of view. Preferably, the sensor interface of the LiDAR sensor is larger than the field of view of the LiDAR sensor, in which the LiDAR sensor transmits and/or receives signals. In this case, the actuator may displace the wiper unit along the sensor surface in order to clean it. If no cleaning of the sensor surface or the field of view is required for a time corridor, the actuator may displace the wiper unit to a parking position. In the parking position, the housing has a protrusion that covers the wiper unit in the parking position or protects it from rockfall or the like.

A further aspect of the invention relates to a vehicle comprising a LiDAR sensor and a LiDAR cleaning system as described above and below.

### BRIEF DESCRIPTION OF THE DRAWINGS

Exemplary embodiments of the invention are described in detail below with reference to the accompanying drawing. The figures show:

FIG. 1 through 5 a LiDAR cleaning system according to one embodiment, and

FIG. 6 a vehicle according to one embodiment.

### DETAILED DESCRIPTION

Preferably, all identical components, elements, and/or units are provided with the same reference symbols in all figures.

FIG. 1 shows a LiDAR cleaning system 10 according to one embodiment. The LiDAR cleaning system 10 is arranged on a LiDAR sensor 100. The LiDAR sensor 100 comprises a sensor surface 102. The field of view 104 of the LiDAR sensor 100 is arranged within the sensor interface 102. The LiDAR cleaning system 10 is configured to displace the wiper unit 20 along the predetermined direction 16 in order to clean the sensor surface 102. Furthermore, the LiDAR cleaning system 10 can displace the wiper unit 20 along the predetermined direction 16 to displace the wiper unit 20 to a parking position 52.

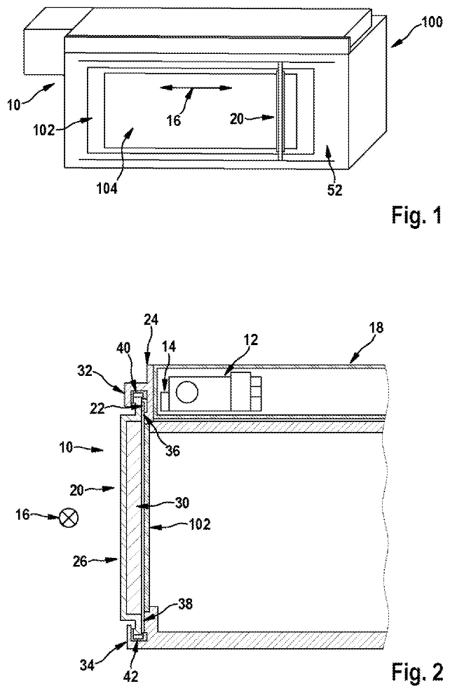

FIG. 2 shows an embodiment of the LiDAR cleaning system 10. The LiDAR cleaning system 10 comprises an actuator 12, which has at least a first connecting means 14. The actuator 12 and the first connecting means 14 may be displaced along a predetermined direction 16. Both the first connecting means 14 and the actuator 12 are arranged in the housing 18. The housing 18 substantially completely encloses the actuator 12 and the first connecting means 14. Furthermore, the LiDAR cleaning system 10 comprises a wiper unit 20. The wiper unit 20 comprises a second connecting means 22. The first connecting means 14 and the second connecting means 22 are force-conductively connected in particular by means of a magnetic connection. Furthermore, the housing 18 is arranged between the first connecting means 14 and the second connecting means 22, as shown in FIG. 2. Furthermore, the housing 18 comprises at least two rails 32, 34. Two webs 36, 38 of the wiper unit 20 are arranged in the rails. Furthermore, a sliding element 40, 42 is arranged in each of the rails 32, 34, which in particular simplifies displacement of the wiper unit 20 along the predetermined direction 16. Furthermore, the wiper unit 20 in particular comprises a guide element 26, which forms a pretensioning force 28, which presses a lip 30 of the wiper unit 20 against the sensor surface 102.

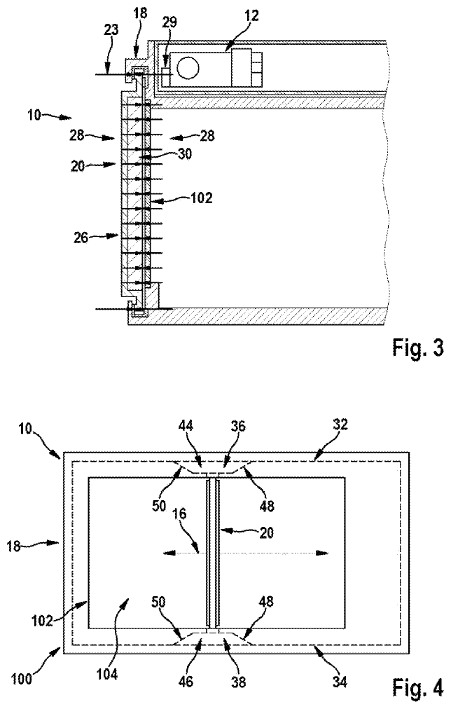

FIG. 3 shows a LiDAR cleaning system 10 according to one embodiment. The LiDAR cleaning system 10 has an actuator 12, which is configured to displace the wiper unit 20 along the sensor surface 102. The housing 18 comprises a guide element 26 configured to form a pretensioning force 28 on a lip 30 of the wiper unit 20 in order to clean the sensor surface 102. For example, the lip 30 and the wiper unit 20 may be fixedly connected to each other. In particular, the housing 18 has a contour, which forms a first support force 29 on the wiper unit 20. The guide element 26 can transmit support force 29 such that a pretensioning force 28 is applied evenly on the lip 30.

FIG. 4 shows a LiDAR cleaning system 10 according to one embodiment. The LiDAR cleaning system 10 is configured to displace the wiper unit 20 along the predetermined direction 16 towards the sensor surface 102. The LiDAR cleaning system 10 comprises a housing 18, which forms two rails 32, 34. A first rail 32 is attached to a top side of the sensor surface 102 and a second rail 34 is attached to a bottom side of the sensor surface 102. Webs 36, 38 of the wiper unit 20 are arranged in the rails 32, 34. The webs 36, 38 each comprise a tilting element 44, 46. Each of the tilting members 44, 46 has a respective slope 48, 50. By displacing the wiper unit 20 along the predetermined direction 16, contaminants can be removed from the rails 32, 34 by means of the slopes 48, 50.

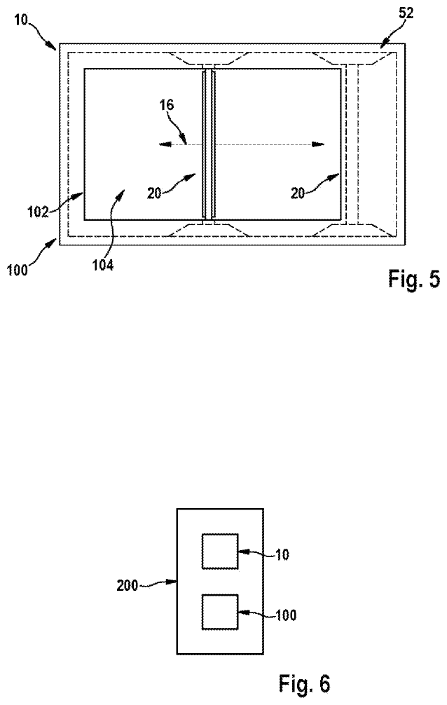

FIG. 5 shows an embodiment of the LiDAR cleaning system 10. The LiDAR cleaning system 10 is arranged on a LiDAR sensor 100. The LiDAR sensor 100 comprises a sensor surface 102 and a field of view 104. The LiDAR cleaning system 10 has a wiper unit 20 which can be displaced along the predetermined direction 16 towards the sensor surface 102 in order to clean the sensor surface 102. If cleaning of the LiDAR sensor 100 is not required for a time corridor, the LiDAR cleaning system 10 can displace the wiper unit 20 to a parking position 52, which is located in particular outside the sensor surface 102 and/or the field of view 104.

FIG. 6 shows a vehicle 200 which has a LiDAR cleaning system 10 and a LiDAR sensor 100.

1. A LIDAR cleaning system (10) comprising:
an actuator (12) configured to displace a first connecting means (14) along a predetermined direction (16),
a housing (18), said housing (18) substantially completely enclosing the actuator (12) and the first connecting means (14),
a wiper unit (20) comprising a second connecting means (22),
wherein the first connecting means (14) and the second connecting means (22) are force-conductively connected to each other, wherein the housing (18) is at least partially arranged between the first connecting means (14) and the second connecting means (22),
wherein the actuator (12) is configured to displace the wiper unit (20) along the predetermined direction (16) via the first connecting means (14) and the second connecting means (22) to clean a sensor surface (102) of a LiDAR sensor (100).

2. The LiDAR cleaning system (10) according to claim 1, wherein the first connecting means (14) and the second connecting means (22) form a magnetic coupling (24) to be force-conductively connected to each other.

3. The LiDAR cleaning system (10) according to claim 1, wherein the first connecting means (14) is a permanent or electromagnetic magnet.

4. The LiDAR cleaning system (10) according to claim 1, wherein the second connecting means (22) is a permanent magnet and/or a magnetizable metal element.

5. The LiDAR cleaning system (10) according to claim 1, wherein the housing (18) comprises at least one guide element (26) configured to form a pretensioning force (28) on a lip (30) of the wiper unit (20) in order to clean the sensor surface (102).

6. The LiDAR cleaning system (10) according to claim 1, wherein the housing (18) comprises two rails (32, 34), wherein the wiper unit (20) comprises two webs (36, 38), wherein the two webs (36, 38) engage the two rails (32, 34) to displace the wiper unit (20) along the sensor surface.

7. The LiDAR cleaning system (10) according to claim 6, wherein the two rails (32, 34) each comprise at least one sliding element (40, 42), wherein the webs (36, 38) abut each sliding element (40, 42).

8. The LiDAR cleaning system (10) according to claim 6, wherein the two webs (36, 38) each comprise a tilting element (44, 46) extending along the two rails (32, 34).

9. The LiDAR cleaning system (10) according to claim 8, wherein each of the tilting elements (44, 46) comprises at least two opposing slopes (48, 50) configured to clean the rails (32, 34) in which the slopes (48, 50) are arranged.

10. The LiDAR cleaning system (10) according to claim 1, wherein the sensor surface (102) has a field of view (104) of the LiDAR sensor 100, wherein the actuator (12) is configured to displace the wiper unit (20) to a parking position (52), wherein the parking position (52) is arranged outside the field of view (104) and/or the sensor surface (102), wherein the housing (18) has a protrusion which covers the wiper unit (20) in the parking position (52).

11. A vehicle (200) comprising a LiDAR sensor (100) and a LiDAR cleaning system (10) according to claim 1.

12. The LiDAR cleaning system (10) according to claim 7, wherein the two webs (36, 38) each comprise a tilting element (44, 46) extending along the two rails (32, 34).

13. The LiDAR cleaning system (10) according to claim 12, wherein each of the tilting elements (44, 46) comprises at least two opposing slopes (48, 50) configured to clean the rails (32, 34) in which the slopes (48, 50) are arranged.
